(19) United States
(12) Patent Application Publication
(10) Pub. No.: US 2008/0052950 A1
(43) Pub. Date: Mar. 6, 2008

(54) Pedestal dryer

(76) Inventors: Sang Ho Park, Changwon-si (KR); Phal Jin Lee, Jinhae-si (KR)

Correspondence Address: MCKENNA LONG & ALDRIDGE LLP;Song K. Jung, 1900 K Street, N.W., Washington, DC, 20006, US

(21) Appl. No.: 11/892,936

(22) Filed: Aug. 28, 2007

(30) Foreign Application Priority Data
Aug. 29, 2006 (KR) 10-2006-0082284

(51) Int. Cl. D06F 58/10; D06F 29/00; F26B 9/06; D06F 35/00

(52) U.S. Cl. 34/524; 68/13 R

(57) ABSTRACT

The present invention relates to a pedestal dryer. More particularly, the present invention relates to new type of dryer for drying as a base supporting a laundry machine. A pedestal dryer includes a container forming a drying per surface on which a laundry machine for washing or drying is mounted, the container forming a drying space in which laundry is held; a hot air supply unit for supplying hot air to the drying space; and a drying degree sensing unit for sensing a drying degree of the laundry.

### CROSS REFERENCE TO RELATED APPLICATION

This application claims the benefit of the Patent Korean Application No. 10-2006-0082284, filed on Aug. 29, 2006, which are hereby incorporated by reference as if fully set forth herein.

### BACKGROUND OF THE DISCLOSURE

1. Field of the Disclosure

The present invention relates to a pedestal dryer. More particularly, the present invention relates to new type of dryer for drying as a base supporting a laundry machine.

2. Discussion of the Related Art

Generally, laundry treating apparatuses are electric home appliances that are capable of washing and/or drying laundry. Specifically, the respective laundry treating apparatuses perform a washing operation, a drying operation, or a washing-and-drying operation. Recently, there has been increasingly used a laundry treating apparatus, including a steam supply unit, that is capable of performing a refreshing operation to remove wrinkles, smells, and static electricity from laundry.

Based on the direction in which laundry is removed, the conventional laundry treating apparatuses are classified into a front loading type laundry treating apparatus and a top loading type laundry treating apparatus. Based on the washing method, on the other hand, the conventional laundry treating apparatuses are classified into a vertical-shaft type laundry treating apparatus, in which a pulsator or a washing tub is rotated, and a horizontal type laundry treating apparatus. A representative example of the horizontal type laundry treating apparatus is a drum type washing machine or a drum type drying machine.

The sizes of the laundry treating apparatuses have been gradually increased to satisfy consumers' demand. Specifically, the exterior sizes of the laundry treating apparatuses for home use have been gradually increased.

However, the large-sized laundry treating apparatuses are operated even to dry a small quantity of laundry, with the result that energy consumption is excessively increased.

For the drum type drying machine, on the other hand, a drum is rotated to tumble an object to be dried. Consequently, the drum type drying machine is not suitable for drying shoes. When shoes are necessary to be washed, a small number of shoes, for example one pair or two pairs of shoes, are normally washed. When the conventional drying machine is used to dry such a small quantity of something to be dried, it is required to drive a drum and, in addition, to drive a large-capacity heater and a large-capacity fan. Consequently, it is very inefficient in an energy saving aspect.

In addition, some consumers may have a desire for a system completely equipped with all the related machines and apparatuses. However, conventional washing-related systems have come into the market very restrictively.

FIG. 1 is a perspective view illustrating a conventional laundry treating apparatus 1.

As shown in FIG. 1, the conventional laundry treating apparatus 1 includes a main body 10 forming the external appearance of the laundry treating apparatus and a control panel 11 mounted at the front or the top of the main body. Here, the control panel 11 may include a control unit for controlling the operation of the laundry treating apparatus. Consequently, a user manipulates the control panel for the laundry treating apparatus to perform a laundry treating operation, such as washing or drying.

Here, the laundry treating apparatus may be a washing machine, a drying machine, or a washing-and-drying machine.

On the other hand, the conventional laundry treating apparatus may further include a base 20 for supporting the main body 10 on the floor. The main body 10 is mounted on the base 20.

However, the base 20 is utilized only to support the conventional washing machine or drying machine. In other words, the utilizability of the base 20 is very low.

### SUMMARY OF THE DISCLOSURE

Accordingly, the present invention is directed to a pedestal dryer capable of drying a small amount of laundry without an operation of a relatively large laundry treating apparatus, being as a base of a laundry machine for washing or drying, as well as capable of sensing a drying degree of the laundry.

An object of the present invention is to provide a pedestal dryer having a compact size without noises, which has an advantage of energy saving and can be efficiently controlled based on a drying degree of laundry, unlike a conventional drum type dryer.

Another object of the present invention is to provide a pedestal dryer which can control a hot air supply unit efficiently by using a sensing result measured by a sensor and can be controlled efficiently by determining a drying time.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. To achieve these objects and other advantages and in accordance with the purpose of the invention, as embodied and broadly described herein, a pedestal dryer includes a container having an upper surface on which a laundry machine for washing or drying is mounted, the container forming a drying space in which laundry is held; a hot air supply unit for supplying hot air to the drying space; and a drying degree sensing unit for sensing a drying degree of the laundry.

The container forms the drying space and the laundry machine may be mounted on an upper surface of the container, which makes the present invention structurally strong.

The drying degree sensing unit senses a drying degree of laundry.

Considering the drying degree sensed by the drying degree sensing unit, the controller may efficiently control the pedestal dryer and may display its information to a user.

The drying degree sensing unit comprises at least one humidity sensor for sensing humidity inside the drying space.

Since the laundry contains much moisture in an early drying period, the humidity inside the drying space is large. As drying is complete, the humidity is getting smaller. As a result, the drying degree may be measured by measuring the humidity.

The drying degree sensing unit senses the drying degree by using a humidity change ratio measured by the humidity sensor.

For example, the humidity of hot air drawn in the drying space is measured by using a humidity sensor provided at a hot air inlet and the humidity of hot air discharged from the drying space is measured by using a humidity sensor provided at a hot air outlet. Hence, the drying degree may be measured from the humidity difference. The humidity difference is large in the early drying period and as drying the laundry is completed, the humidity difference is getting smaller. By using that, the drying degree may be measured.

A plurality of humidity sensors may be provided at various positions inside the drying space. If using an average of the humidity measured by the humidity sensors, sensing errors may be decreased.

The drying degree sensing unit comprises at least one temperature sensor for sensing a temperature inside the drying space. Like the humidity sensors, a plurality of temperature sensors may be provided at various positions inside the drying space.

Since heat energy of the hot air is used to dry the laundry, the temperature inside the drying space is getting high by the heat energy as the drying is complete. As a result, the drying degree may be measured.

The temperature sensor may be used to sense whether the temperature inside the drying space is overheated. If the temperature inside the drying space is overheated, it is preferable that the hot air supply unit is controlled to be off. As a result, damage to the laundry as well as a fire is prevented.

In addition, an operation of the hot air supply unit may be controlled based on the temperature measured by the temperature sensor. For example, the controller may control the hot air supply unit to increase the temperature of the amount of the hot air if the temperature is relatively low.

The drying degree sensing unit senses the drying degree by using a temperature change ratio measured by the temperature sensor, which is similar to the case of using the humidity change ratio.

The drying degree sensing unit senses the drying degree by using an interrelation between the temperature measured by the temperature sensor provided at the hot air inlet of the drying space and the temperature measured by the temperature sensor provided at the hot air outlet of the drying space.

The drying degree sensing unit comprises a weight sensor for sensing a weight of the laundry.

Since the laundry contains a lot of moisture, the weight of the laundry may be large. As the drying is performed, the weight is getting light. Thus, using that, the drying degree may be measured.

The drying degree sensing unit senses the drying degree by using a weight change ratio measured by the weight sensor, which is similar to the cases of using the humidity sensor or the temperature sensor.

The drying time may be determined by using the weight sensor. For example, if the laundry is heavy, it is determined that there is much laundry and the drying time is set as a long drying time. If the laundry is light, the drying time is set as a short drying time.

The drying degree sensing unit may include a micom for determining a drying degree by suing the data measured by the sensors.

The drying degree sensing unit may include all of the humidity sensor, the temperature sensor and the weight sensor.

It is preferable that a volume and a height of the pedestal dryer are smaller and lower than a volume and a height of the laundry machine, respectively. This is because the pedestal dryer performs an auxiliary function of the laundry machine.

It is preferable that the pedestal dryer is coupled to the laundry machine by a coupling means securely. Since the laundry machine vibrates during the rotation, the laundry machine should be supported on the pedestal dryer securely.

As the pedestal dryer including the input unit, the display unit and the main controlling unit may be independently operated without depending on another apparatus, the pedestal dryer may be provided auxiliary in the apparatus, for example, a washer or dryer.

If a user tries to use the pedestal dryer, he/she inputs a command for drying by operating the input unit. Hence, the main controlling unit controls the pedestal dryer based on the inputted command and it displays information relating to a corresponding operational state through the display unit.

The hot air supply unit may include a ventilation fan for ventilating air and a heater for heating the air. Although it may be provided in the container, the hot air supply unit may be provided in other devices.

If the hot air supply unit is provided in other devices such as a dryer, auxiliary means such as a pipe should be necessary to receive the hot air.

It is preferable that the pedestal dryer includes a steam supply unit for supplying steam to the laundry.

The container may include a drawer retractable. The drawer allows the laundry to be loaded and unloaded smoothly, and to be washed easily.

An inlet is formed at an upper portion of a rear wall of a body defining an exterior of the pedestal dryer. An outlet is formed at a lower portion of a rear wall of the body. An upper portion of a rear side of the drawer is in communication with the inlet and a lower portion of a rear side of the drawer is in communication with the outlet.

The heater may be positioned in front of the inlet and the ventilation fan may be positioned in front of the outlet.

The hot air supply unit and the steam supply unit may be provided between the rear side of the drawer and the rear wall of the body.

The pedestal dryer may further include a shelf on which the laundry is put. The shelf divides an inner space of the drawer into an upper and lower portion, the upper and lower portion being in communication with each other. A plurality of through holes may be formed to make the upper and lower portion be in communication with each other.

Here the shelf may be oblique downward to an air inlet direction. As a result, the hot air is directly and uniformly supplied to the laundry put on the shelf.

If the shelf is oblique, water in shoes may flow down which is advantageous in drying.

In addition, if the shelf is oblique, the drawn hot air collides against the shelf and the hot air is flowing to a lower portion of the shelf such that the hot air is circulated smoothly.

In addition, an air guide is provided at the rear side of the drawer to guide the air to an upper portion in the drawer. The air drawn into the upper portion of the drawer is guided to the laundry, not flowing downward, to improve drying efficiency.

According to the present invention, the user can dry a normal amount or a large amount of laundry by using the laundry machine mounted on the pedestal dryer and can dry a small amount of laundry by using the pedestal dryer. As a result, user convenience may be enhanced and energy may be economized.

Furthermore, the pedestal dryer according to the present invention is applicable to drying laundry that is difficult to dry in the conventional drum type dryer, for example, shoes or hats.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a perspective view illustrating a conventional laundry treating apparatus including a base;

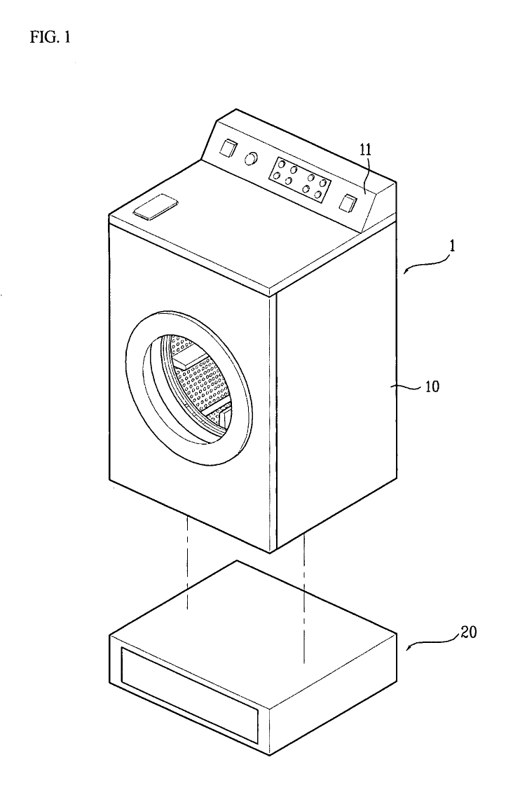

FIG. 2 is a perspective view illustrating a combined laundry machine including a pedestal dryer according to the present invention;

FIG. 3 is an exploded perspective view of the pedestal dryer;

FIG. 4 is a sectional view of the pedestal dryer including a humidity sensor according to an embodiment of the present invention;

FIG. 5 is a sectional view of the pedestal dryer including a temperature sensor according to another embodiment of the present invention; and

FIG. 6 is a sectional view of the pedestal dryer including a weight sensor according to a further embodiment of the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

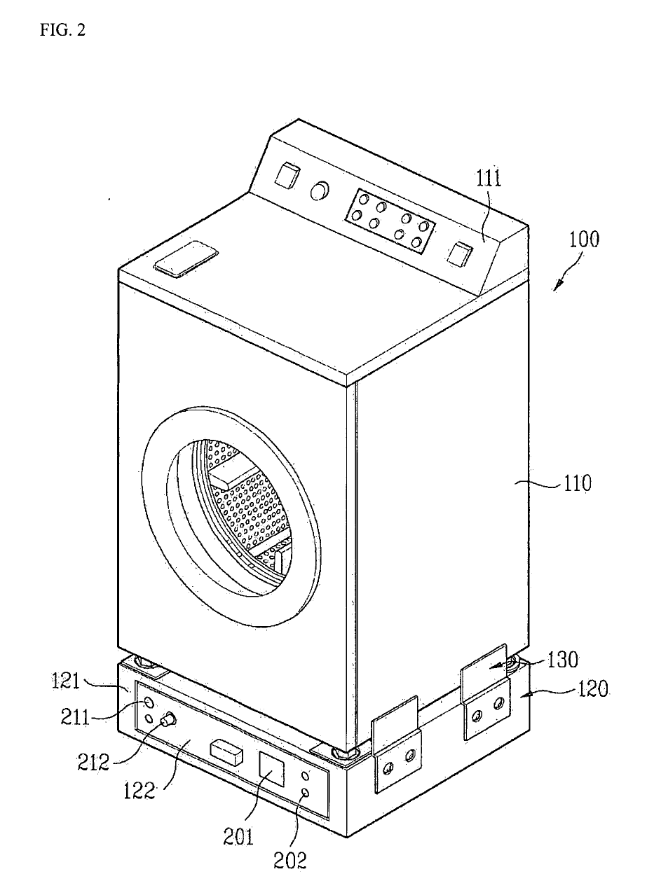

In reference to FIGS. 2 to 4, a pedestal dryer according to the present invention will be explained.

As shown in FIG. 2, the pedestal dryer 120 serves as a base for supporting a body 110 of a laundry treating apparatus such as a washer or a dryer.

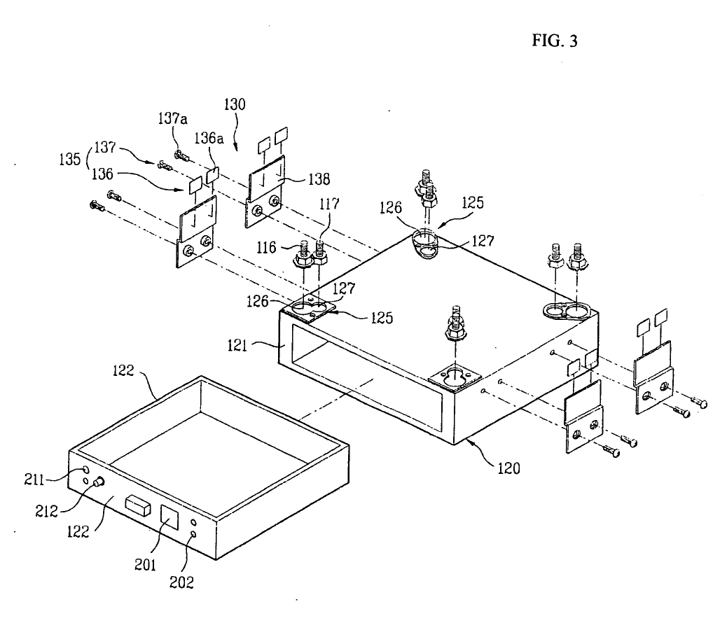

As shown in FIGS. 2 and 3, the pedestal dryer 120 according to an embodiment includes a container 121 and a coupling unit 130. The container 121 forms a predetermined space for holding laundry in the pedestal dryer 120. The coupling unit 130 is provided in an upper portion of the container 121 to couple the body 110 to the container 121. Here, the pedestal dryer 120 supports the body 110 of the laundry machine for washing or drying with respect to the floor.

In addition, there may be a plurality of leg supporters 125 provided at an upper surface of the pedestal dryer 120 to support sides of lower legs 116 and 117.

Each of the leg supporters 125 is formed of a panel having a first seating hole 126 and a second seating hole 127 and it is fixed to the upper surface of the container 121 by a screw. Here, a washer leg 116 is seated in the first seating hole 126 and a dryer leg 117 is seated in the second seating hole 127.

The leg supporters 125 are fixed to upper corners of the container 121, respectively. while the first seating hole 126 and the second seating hole 127 formed at the two leg supporters fixed at front corners of the container 121 are connected each other, the first seating hole 126 and the second seating hole 127 formed at the two leg supporters fixed at rear corners of the pedestal dryer are divided each other. This is for the washer legs 116 to be seated easily.

With respect to a diagonal line of a lower surface of the body 110, the first seating hole 126 is positioned outer than the second seating hole 127. This is because the body of the washer is commonly larger than the body of the dryer.

The coupling unit 130 includes a coupling member 138 and a fixing member 135. The coupling member 138 is provided at a side of the laundry machine for washing or drying and at a side of the container 121. The fixing member 135 fixes the coupling member 138 to the side of the laundry machine and the side of the container 121.

As shown in FIG. 3, the fixing member is formed of more than two coupling members 138 for fixing the sides of the hexahedron container 121 to the sides of the hexahedron body 110 of the laundry machine.

In addition, the coupling member may further include a third coupling member (not shown) for fixing the container 121 to a rear surface of the body 110.

Here, the coupling unit 130 may be adjusted to the height of the washer leg 116 or the dryer leg 117.

The fixing member 135 includes a first fixing member 136 and a second fixing member 137. The first fixing member 136 fixes an upper portion of the coupling member to a lower side surface of the laundry machine. The second fixing member 137 fixes a lower portion of the coupling member to an upper side surface of the laundry machine.

Here, at least one of the first and second fixing members 136 and 137 may be configured of material having adhesive coated on both surfaces thereof, for example, a double coated adhesive tape.

Alternatively, at least of the first and second fixing member 136 and 137 may be configured of coupling means such as screws.

If the fixing member is a screw, it is preferable that the upper portion of the coupling member has a coupling hole formed in a predetermined distance.

On the other hand, coupling means between the body 110 of the laundry machine and the container 121 of the pedestal dryer 120 may be varied.

According to the present invention, it is preferable that a volume of the pedestal dryer is smaller than a volume of the laundry machine to which the pedestal dryer 120 is coupled and it is also preferable that a height of the pedestal dryer is lower than a height of the laundry machine. For that, it is preferable that the volume and the height of the container 121 may be smaller and lower than a volume and a height of the body 110. This is because the pedestal dryer is employed to perform an auxiliary function of the laundry machine.

Considering safety or an exterior design of the combined laundry machine 100, it is preferable that at least one of a right-and-left width or a forward-and-backward width of the container 121 is the same as or longer than a right-and-left width or a forward-and-backward width of the body 110.

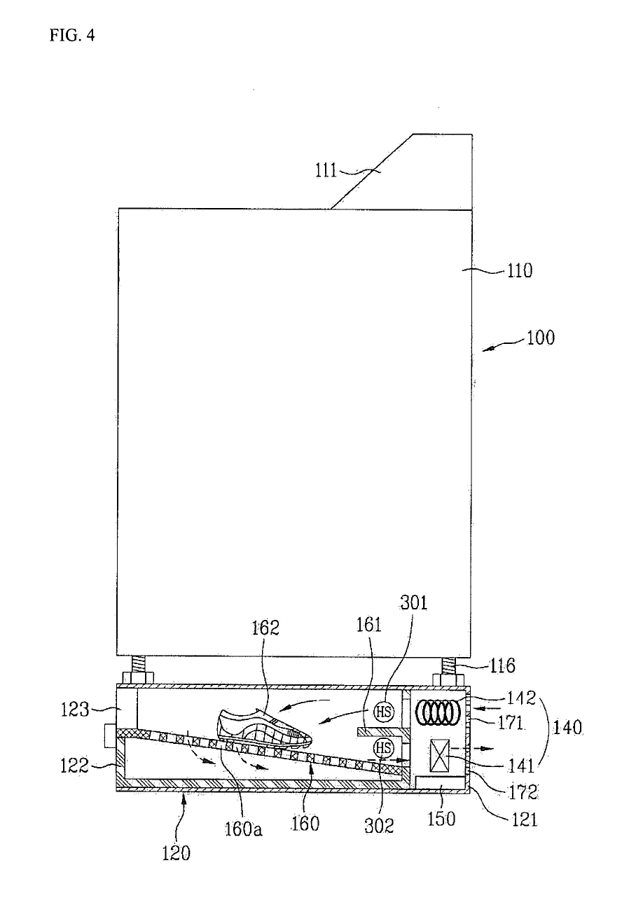

Next, in reference to FIG. 4, a configuration of the pedestal dryer according to the present invention will be explained in detail.

FIG. 4 is a sectional view schematically illustrating the configuration of the pedestal dryer.

The pedestal dryer 120 according to the present invention may be coupled to the body 110 of the laundry machine to form one combined laundry machine for washing or drying 100. In this case, the laundry is loaded in the body 110 for defining an exterior appearance of the laundry machine and thus the laundry is washed or dried. That is, the laundry machine may be a washer, a dryer or a washer having a drying function.

The combined laundry machine 100 includes the coupling unit 130 for fixing the container 121 of the pedestal dryer 120 to a predetermined portion of the body 110 of the laundry machine. The coupling unit 130 is not shown in FIG. 4.

The pedestal dryer 120 forms a predetermined drying space for holding the laundry therein. Here, the drying space may be configured of a drawer 122 retractable from a front surface of the container 121. The pedestal dryer 120 further includes a hot air supply unit 140 provided in the container to forcibly supply hot air to the drying space.

In addition, the pedestal dryer 120 further includes a steam supply unit 150 provided in the container 121 to supply steam to the drying space. The steam supply unit 150 includes a steam injection hole (not shown) provided at an upper or lower portion and the steam is injected to the drying space through the steam injection hole (not shown).

Here, operations of the hot air supply device 140 and the steam supply unit 150 are controlled by a main controlling unit provided at the controller 123.

The controller 123 further includes an input unit and a display unit. A knob 212 and various selection buttons 211 are provided as the input unit and a user may select various courses including a drying course. Also, an LCD display 201 and an LED 202 are provided as the display unit.

The hot air supply unit 140 includes a ventilation fan 141 for ventilating air and a heater 142 for heating the air. That is, the ventilation fan 141 is operated to draw external air into the drawer 122 and to discharge the air. The external air is heated at the heater 142 and drawn in the drawer 122.

Here, the heater 142 may be varied such as an electric type or a gas type. Considering an installation space of the pedestal dryer, it is preferable that the heater 142 is an electric type.

As a result, the pedestal dryer 120 can perform a drying function by using the hot air supply device 140. Here, it is preferable that the heater 142 is a capacity adjustable heater in that temperatures of the heated air may be variable, because particular fabric of the laundry may be fragile to heat or especially rubber of shoes may be fragile to the heat.

The steam supply unit 150 supplies the steam to the drawer 122. Such steam is supplied to the laundry in the drawer to sterilize the laundry and to remove wrinkles of the laundry. As a result, the pedestal dryer 120 according to the present invention may perform a refresh function by using the steam supply unit 150. Here, a drying function may be performed together with the refreshing function.

On the other hand, an inlet 171 is formed at an upper portion of a rear wall of the container 121 and air is drawn in the container 121 through the inlet 171. An outlet 172 is formed at a lower portion of the rear wall and air is discharged through the outlet 172. An upper portion of a rear side of the drawer 122 is in communication with the inlet 171 and a lower portion of the rear wall of the drawer 122 is in communication with the outlet 172. As a result, external air is drawn in the drawer 122 through the upper portion of the rear wall of the container 121 and the upper portion of the drawer 122. The air is discharged through the lower portion of the rear wall of the container 121 and the lower portion of the drawer 122.

Here, the ventilation fan 141 for forcibly ventilating the air and the heater 142 for heating the air may be provided between the rear side of the drawer 122 and a rear wall of the body 110. However, it is not limited thereto and the hot air supply unit 140 including the ventilation fan 141 and the heater 142 may be provided at any position of the path through which the air is drawn and discharged.

FIG. 4 shows that air is drawn through the upper portion of the drawer and discharged through the lower portion. While, it is possible that the air is drawn through the lower portion of the drawer and discharged through the upper portion.

The laundry 162 is loaded in the drawer 122 and a shelf 160 may be provided to divide an inner space of the drawer horizontally in communication with each other. This shelf helps the air supplied to the laundry 162 to be discharged smoothly.

It is preferable that a plurality of through-holes 160a may be formed at the shelf 160. The air in the upper portion of the drawer is drawn into the lower portion through the through-holes 160a.

In addition, the shelf 160a may be oblique. In this case, the shelf is oblique downward to an air inlet portion such that the air may be supplied to the laundry on the shelf.

It is preferable that an air guide 161 is provided at an upper portion of the rear side of the drawer. The air guide 161 allows the air to be supplied to a front portion of the drawer smoothly and divides a path into an air inlet path and an air outlet path. As a result, collision between the drawing air and the discharging air is minimized, only to enhance drying efficiency.

In the meantime, various types of drying modes may be performed by using the pedestal dryer.

First, a user retracts the drawer 122 and puts a small amount of clothes, shoes or hats on the shelf 160. If the laundry is clothes, it is preferable that the clothes are folded.

The user selects an operational mode according to the kind of the laundry by using the input unit of the controller 123. The operational modes include various types of drying modes and refreshing modes.

The various types of drying modes may be classified into drying times or drying temperatures according to kinds of laundry fabrics. For example, to dry a small amount of laundry, a drying mode is set as a short drying time and a high drying temperature. To dry shoes, a drying mode is set as a long drying time and a low drying temperature.

That is, air is forcibly supplied to the inner space having the laundry according to the operational mode selected by the user, and the temperature of the air or the air supply time may be varied.

If an operational mode is refresh mode, high temperature steam is supplied to the laundry. Thus, refreshing the laundry is performed by the steam which means that bad smell of the laundry and wrinkles of the laundry may be removed and that sterilization of the laundry may be performed. After that, air for drying may be supplied if necessary.

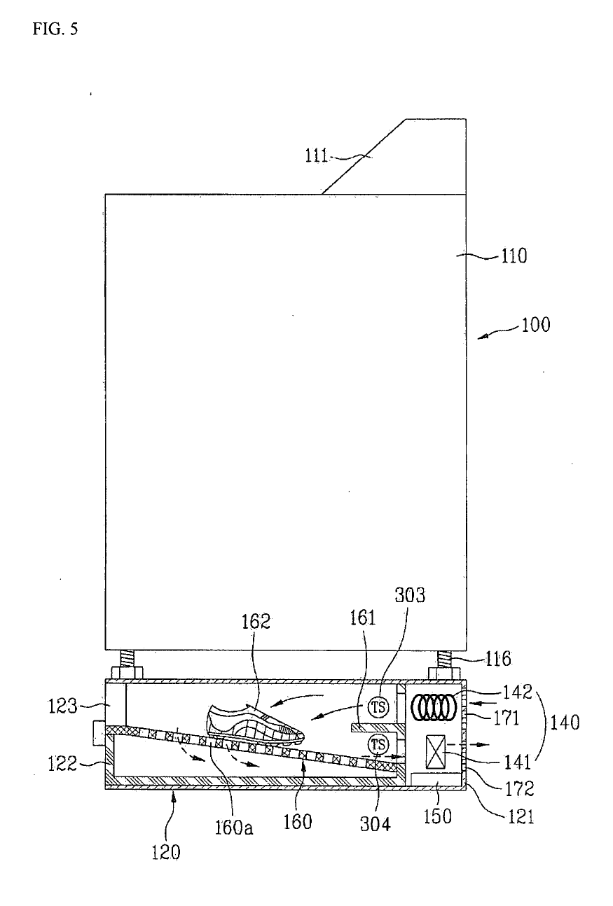

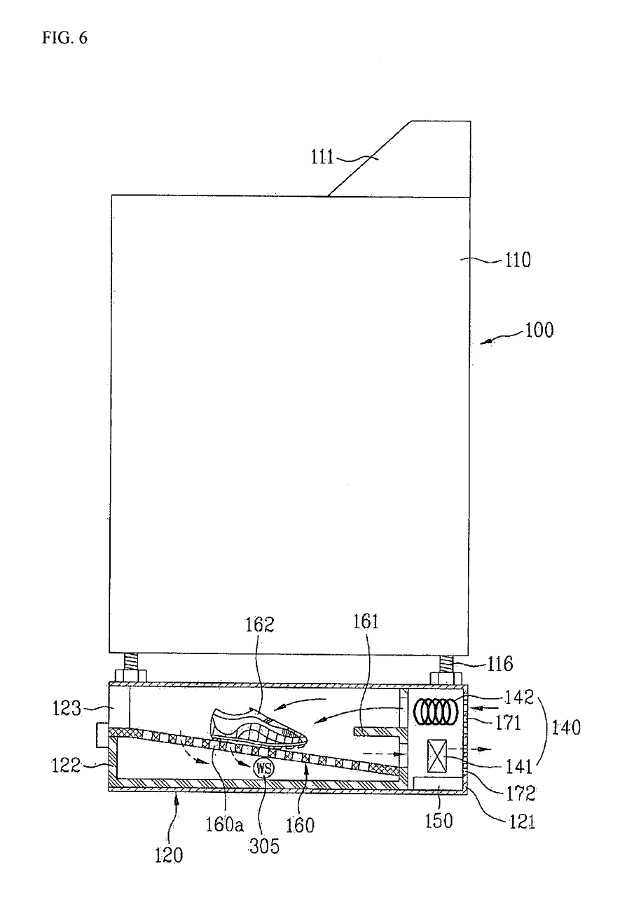

Next, a drying degree sensing unit will be explained. FIG. 4 shows that the drying degree sensing unit includes a humidity sensor. FIG. 5 shows that it includes a temperature sensor. FIG. 6 shows that it includes a weight sensor.

As shown in FIG. 4, the humidity sensor 301 is provided at a hot air inlet of the drying space and the humidity sensor 302 is provided at a hot air outlet of the drying space.

The inlet humidity sensor 301 measures humidity of the hot air drawn in the drying space and the outlet humidity sensor 302 measures humidity of the hot air discharged from the drying space.

Considering a difference between the humidity at the inlet and the humidity at the outlet, the micom (not shown) determines a drying degree of the laundry.

If the difference of the humidity is large, it is determined that drying is performed actively. If the difference of the humidity is below a standard value, it is determined that drying is almost finished.

The drying degree may be measured by using the humidity measured by a humidity sensor 302 provided at the outlet. Briefly, if the humidity is over a standard value, it is determined that the laundry is still wet. If the humidity is below the standard value, it is determined that drying is almost finished.

Also, a micom calculates a ratio of the humidity measured by the humidity sensor 302 at the outlet. Hence, if the ratio is below a standard value, it may be determined that drying the laundry is almost finished. At this time, it is preferable that the drying degree is determined by using the ratio in a predetermined time period.

By the way, the controller may an operation of the hot air supply unit 140 by using the humidity measured by the humidity sensor 302 at the outlet. For example, if the humidity is large, the hot air supply unit 140 may be controlled to increase the temperature of the hot air or the amount of the hot air.

FIG. 5 shows that a temperature sensor is provided. The temperature sensors 303 and 304 are provided at the inlet and the outlet, respectively, like in FIG. 4.

The micom determines the drying degree of the laundry by using differences between the temperature measured by the temperature sensor 303 at the inlet and the temperature measured by the temperature sensor 304 at the outlet. If the temperature difference is below a standard valve, it is determined that drying the laundry is almost finished.

The drying degree may be determined by using the temperature measured by the temperature sensor 304 at the outlet. Since heat energy of the hot air is used to dry the laundry in an early course of drying, the temperature at the outlet may be low. As the drying is complete, the temperature at the outlet will increase. Considering that, the drying degree is determined.

The drying degree may be determined by using a ratio of temperature differences at the outlet, which is similar to the case of the above humidity sensor.

The temperature sensor 303 at the inlet or the temperature sensor 304 at the outlet may be used to sense overheat of an inside of the drying space.

If the temperature measured by the temperature sensor 303 at the inlet or the temperature sensor 304 at the outlet is over a standard value, the micom determines that the inside of the drying space is overheated. Hence, the controller the hot air supply unit 140 to be switched off.

In addition, the controller may receive information of differences between the temperature at the inlet and the temperature at the outlet and it uses the information in efficient control of the hot air supply unit 140. For example, if the difference is large, the controller controls the temperature of the hot air or the amount of the hot air to increase. If it is small, the controller controls vice versa. As a result, the hot air supply unit 140 may be controlled more efficiently. In addition, such control may be applicable to a case of using the humidity sensor.

In the same way, considering the temperature at the outlet, the controller controls the hot air supply unit 140 efficiently.

FIG. 6 shows that a weight sensor 305 is used. As shown in FIG. 6, the weight sensor 305 is provided under the shelf 160. The weight sensor 305 may be provided on the shelf 160.

The micom determines the drying degree of the laundry by using the weight measured by the weight sensor 305.

If a ratio of the weights measured by the weight sensor 305 is below a standard value, it is determined that drying the laundry is almost finished.

In addition, the amount of the laundry is determined by using the weight measured in an early period of the drying and the drying time is determined.

As mentioned above, considering the ratio of the weight differences, the controller may control the hot air supply unit 140 efficiently.

The present invention may include other various sensors rather than the above embodiments and the drying degree may be sensed by using them.

According to pedestal dryer of the present invention, drying a small amount of laundry may be dried without an operation of a relatively large laundry treating apparatus and employed as a base of the laundry machine for washing or drying. In addition, the pedestal dryer according to the present invention can sense the drying degree of the laundry.

Unlike the conventional dryer, the pedestal dryer is not a drum type dryer and thus it has an advantage of energy saving without nose. In addition, the pedestal dryer according to the present invention may be compact in a small size.

Furthermore, the pedestal dryer according to the present invention may adjust the drying time and the temperature of the heater or the rotational speed of the ventilation fan. In addition, the pedestal dryer according to the present invention may operate the hot air supply unit efficiently.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A pedestal dryer comprising:
a container having an upper surface on which a laundry machine for washing or drying is mounted, the container forming a drying space in which laundry is held;
a hot air supply unit for supplying hot air to the drying space; and
a drying degree sensing unit for sensing a drying degree of the laundry.

2. The pedestal dryer of claim 1, wherein a volume and a height of the pedestal dryer is smaller and lower than a volume and a height of the laundry machine, respectively.

3. The pedestal dryer of claim 1, further comprising a coupling unit provided at an upper portion of the container to couple the laundry machine to the container.

4. The pedestal dryer of claim 1, wherein the pedestal dryer is configured of a base for supporting a lower portion of the laundry machine with respect to the floor.

5. The pedestal dryer of claim 1, wherein the drying degree sensing unit comprises at least one humidity sensor for sensing humidity inside the drying space.

6. The pedestal dryer of claim 5, wherein the drying degree sensing unit senses the drying degree by using a humidity change ratio measured by the humidity sensor.

7. The pedestal dryer of claim 5, wherein the drying degree sensing unit senses the drying degree by using an interrelation between the humidity measured by the humidity sensor provided at an hot air inlet of the drying space and the humidity measured by the humidity sensor provided at an hot air outlet of the drying space.

8. The pedestal dryer of claim 1, wherein the drying degree sensing unit comprises at least one temperature sensor for sensing a temperature inside the drying space.

9. The pedestal dryer of claim 8, wherein the drying degree sensing unit senses the drying degree by using a temperature change ratio measured by the temperature sensor.

10. The pedestal dryer of claim 8, wherein the drying degree sensing unit senses the drying degree by using an interrelation between the temperature measured by the temperature sensor provided at the hot air inlet of the drying space and the temperature measured by the temperature sensor provided at the hot air outlet of the drying space.

11. The pedestal dryer of claim 8, further comprising a controller for controlling the hot air supply unit by using the temperature measured by the temperature sensor.

12. The pedestal dryer of claim 1, wherein the drying degree sensing unit comprises a weight sensor for sensing a weight of the laundry.

13. The pedestal dryer of claim 12, wherein the drying degree sensing unit senses the drying degree by using a weight change ratio measured by the weight sensor.

14. The pedestal dryer of claim 12, further comprising a controller for determining a drying time by using the weight measured by the weight sensor.

15. A combined laundry machine comprising:
a laundry machine for washing or drying;
a pedestal dryer comprising a container forming a drying space in which laundry held and having an upper surface for the laundry machine to be mounted on, a hot air supply unit for supplying hot air to the drying space, and a drying degree sensing unit for sensing a drying degree of the laundry.

16. The combined laundry machine of claim 15, wherein a volume and a height of the pedestal dryer is smaller and lower than a volume and a height of the laundry machine, respectively.

17. The combined laundry machine of claim 15, further comprising a coupling unit provided at an upper portion of the container to couple the laundry machine to the container.

18. The combined laundry machine of claim 15, wherein the pedestal dryer is configured of a base for supporting a lower portion of the laundry machine with respect to the floor.
